(19) United States
(12) Patent Application Publication
(10) Pub. No.: US 2006/0062682 A1
(43) Pub. Date: Mar. 23, 2006

(54) Scroll compressor having refrigerant gas guide structure

(75) Inventors: Nam-Kyu Cho, Gyeonggi-Do (KR); Dong-Koo Shin, Anyang (KR); In-Hwe Koo, Gyeonggi-Do (KR); Jin-Sung Park, Gwangmyeong (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/211,431

(22) Filed: Aug. 26, 2005

(30) Foreign Application Priority Data
Sep. 20, 2004 (KR) 76213/2004

(51) Int. Cl. F01C 1/02; F04C 2/00; F03C 4/00; F01C 1/063; F04C 18/00

(52) U.S. Cl. 418/55.5; 418/55.1

(57) ABSTRACT

A scroll compressor having a refrigerant gas guide structure includes: a casing forming a hermetic receiving space therein, and having a suction pipe for sucking a refrigerant gas and a discharge pipe for discharging a refrigerant gas; a fixed scroll having a wrap of an involute shape and a discharge hole for discharging a compressed refrigerant gas, and disposed in the casing; an orbiting scroll having a wrap of an involute shape, coupled with the fixed scroll and orbiting relative to the fixed scroll; and a gas guide member installed in the casing, for guiding the refrigerant gas discharged through the discharge hole.

### BACKGROUND OF THE INVENTION

1. Field of the Invention

The present invention relates to a scroll compressor having a refrigerant gas guide structure, and more particularly, to a scroll compressor having a refrigerant gas guide structure which guides a course of a refrigerant gas in order to prevent lubrication oil from being spilt into the outside of a casing together with the refrigerant gas when the refrigerant gas inside the casing is discharged outside the casing through a discharge pipe.

2. Description of the Background Art

In general, a scroll type compressor is a high efficiency and low noise compressor widely applied in the field of air conditioners, and has a structure that a refrigerant gas is successively compressed and discharged by continuously moving a plurality of compression chambers formed between a fixed scroll and an orbiting scroll toward the center portion of the orbiting scroll during the relative orbital movement of the fixed scroll and the orbiting scroll.

FIG. 1 is a longitudinal section view showing a conventional scroll compressor.

As shown in FIG. 1, the conventional scroll compressor 1 includes: a casing 11 forming a hermetic receiving space therein; a compression part 41 received in the casing 11 and compressing a refrigerant gas; and a motor part 31 installed inside the casing 11 and supplying a driving force to the compression part 41.

A suction pipe 13 for sucking a refrigerant gas is formed at one side of the casing 11, and a discharge pipe 15 for discharging a refrigerant gas is formed at the other side of the casing 11.

Inside the casing 11, an upper frame 21 and a lower frame 30 are separately installed at upper and lower parts of the casing 11 in order to support the compression part 41 and the motor part 31.

The compression part 31 includes a stator 33 installed in the casing 11 and a rotor 35 rotatably received/installed, centering around a rotary shaft 36 vertically disposed in the stator 33.

An eccentric portion 37 is formed at an upper portion of the rotary shaft 36, and a lubrication oil supply path 38 for supplying lubrication oil 18 contained in a lubrication oil storing part 17 of a lower portion inside the casing 11 to the compression part 41 is formed inside the rotary shaft 36.

A lubrication oil supply part 39 is formed at a lower portion of the rotary shaft 36 so that the lubrication oil 18 stored in the lubrication storing part 17 of the lower portion inside the casing 11 can be supplied to the compression part 41 along the lubrication oil supply path 38 during the rotation of the rotary shaft.

The compression part 41 includes a fixed scroll 43 having a wrap 44 of an involute shape and coupled to an upper side of the upper frame 21, and an orbiting scroll 53 having a wrap 54 of an involute shape, forming a compression space of a refrigerant gas by being interlocked with the fixed scroll 43, coupled with the eccentric part 37 and orbiting relative to the eccentric part 37. A discharge hole 45 for discharging the compressed refrigerant gas is formed at the center portion of an upper surface of the fixed scroll 43.

A first gas passage hole 61 is formed between the casing 11 and the upper frame 21 and between the casing 11 and the fixed scroll 43, a second gas passage hole 63 is formed between the casing 11 and one part of the stator 33, and a third gas passage hole 65 is formed between the casing 11 and the counter part of the stator 33.

The operation of the conventional scroll compressor having such construction will be described.

As shown in FIG. 1, when the power is applied to the motor part 31 and thus the rotor 35 is rotated centering around the rotary shaft 36, the orbiting scroll 53 coupled with the eccentric part 37 orbits with respect to the fixed scroll 43. At this time, a refrigerant gas sucked through the suction pipe 13 moves toward the center portion of the fixed scroll 43, is compressed, and then is discharged through the discharge hole 45. The discharged refrigerant gas is discharged outside the discharge pipe 15 after passing through the first gas passage hole 61 or is discharged outside the discharge pipe 15 after passing through the first gas passage hole 61, the second gas passage hole 63 and the third gas passage hole 65. After circulating according to a freezing cycle, the refrigerant gas having been discharged to the outside of the casing 11 flows into the casing 11 again through the suction pipe 13. Such processes are repeated.

Simultaneously, the lubrication oil supply part 39 supplies the lubrication oil 18 stored in the lubrication storing part 17 to each constituting part such as the compression part 41 along the lubrication oil supply path 38. The lubrication oil having been supplied to each constituting part is returned to the lubrication oil storing part 17.

However, in the conventional scroll compressor having such construction, when the refrigerant gas having been discharged through the discharge hole 45 moves from the upper part to the lower part of the casing 11 and is discharged outside the casing 11 through the discharge pipe 15, the lubrication oil 18 having been supplied to the compression part 41 along the lubrication oil supply path 38 is also discharged outside the casing. Therefore, the lubrication oil filled to prevent abrasion of each constituting part cannot be maintained in the necessary amount of but becomes in short supply, which causes each part to be subject to abrasion and thus brings about deterioration of the performance of each part. As a result, the compression performance of the compressor is degraded.

### SUMMARY OF THE INVENTION

Therefore, an object of the present invention is to provide a scroll compressor having a refrigerant gas guide structure capable of enhancing the compression performance of the scroll compressor by reducing the occurrence of abrasion of each part by leaving the proper amount of lubrication oil in a casing all the time by efficiently preventing the lubrication oil from being spilt into the outside of the casing together with the refrigerant gas by guiding a course of the refrigerant gas.

To achieve these and other advantages and in accordance with the purpose of the present invention, as embodied and broadly described herein, there is provided a scroll compressor having a refrigerant gas guide structure, comprising: a casing forming a hermetic receiving space therein, and having a suction pipe for sucking a refrigerant gas and a discharge pipe for discharging a refrigerant gas; a fixed scroll having a wrap of an involute shape and a discharge hole for discharging a compressed refrigerant gas and disposed in the casing; an orbiting scroll having a wrap of an involute shape, coupled with the fixed scroll and orbiting relative to the fixed scroll; and a gas guide member installed in the casing, for guiding the refrigerant gas discharged through the discharge hole.

A first gas passage hole is formed between the casing and an upper frame and between the casing and the fixed scroll, a second gas passage hole is formed between the casing and one part of a stator, and a third gas passage hole is formed between the gas guide member and the casing, and a fourth gas passage hole is formed between the casing and the counter part of the stator.

The refrigerant gas having been discharged through the discharge hole passes the first gas passage hole, the third gas passage hole, the second passage hole and the fourth passage hole and then is discharged-outside the discharge pipe.

Flange parts coupled with the inside of the casing are curvedly formed at both sides of the gas guide member, respectively.

A gas exhaust hole is formed at the center of the gas guide member such that a part of a refrigerant gas passing the third gas passage hole can be introduced outside the discharge pipe.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal section view showing a conventional scroll compressor;

FIG. 2 is a longitudinal section view showing a scroll compressor having a refrigerant gas guide structure in accordance with a first embodiment of the present invention;

FIG. 3 is a lateral section view of FIG. 2;

FIG. 4 is an enlarged perspective view showing an important part of the scroll compressor having a refrigerant gas guide structure in accordance with the first embodiment of the present invention;

FIG. 5 is a longitudinal section view of a scroll compressor having a refrigerant gas guide structure in accordance with a second embodiment of the present invention;

FIG. 6 is an enlarged view of “A” of FIG. 5;

FIG. 7 is a enlarged perspective view showing an important part of the scroll compressor having a refrigerant gas guide structure in accordance with the second embodiment of the present invention;

FIG. 8 is an enlarged perspective view showing an important part of the scroll compressor having a refrigerant gas guide structure in accordance with a third embodiment of the present invention; and

FIG. 9 is an enlarged perspective view showing an important part of a scroll compressor having a refrigerant gas guide member in accordance with a fourth embodiment of the present invention.

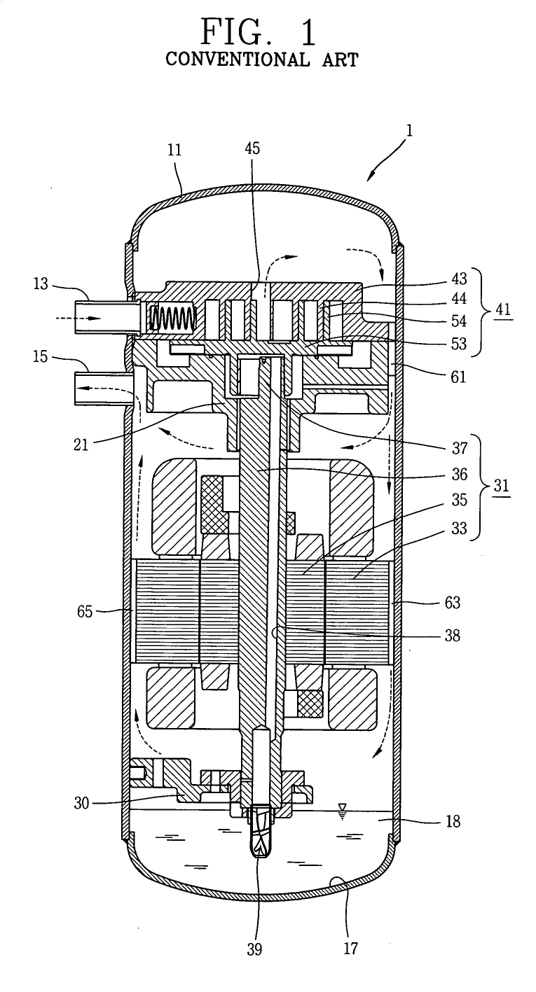

### DETAILED DESCRIPTION OF THE PREFERRED EMBODIMENTS

Reference will now be made in detail to the preferred embodiments of the present invention, examples of which are illustrated in the accompanying drawings.

Hereinafter, a scroll compressor having a refrigerant gas guide structure in accordance with the present invention will be described with reference to the accompanying drawings.

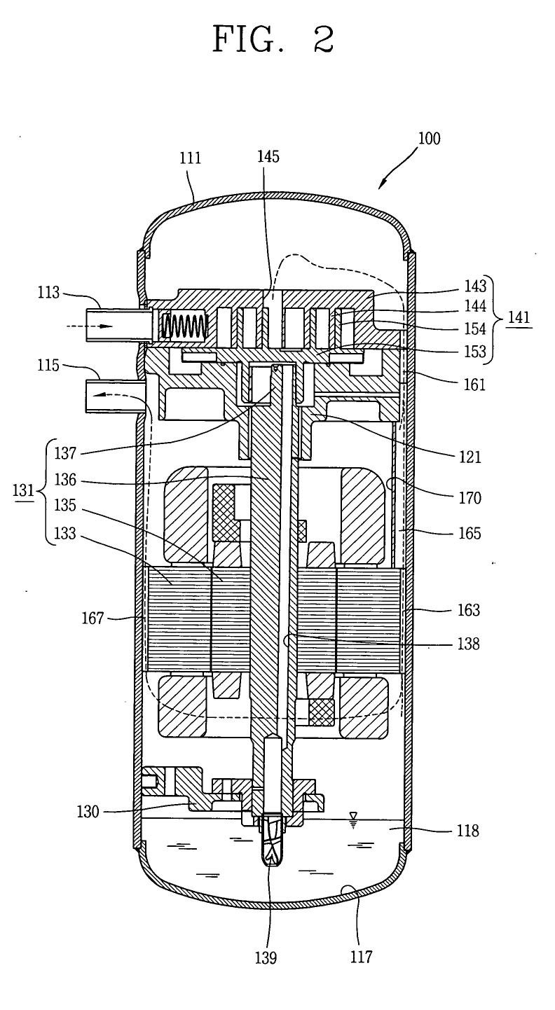

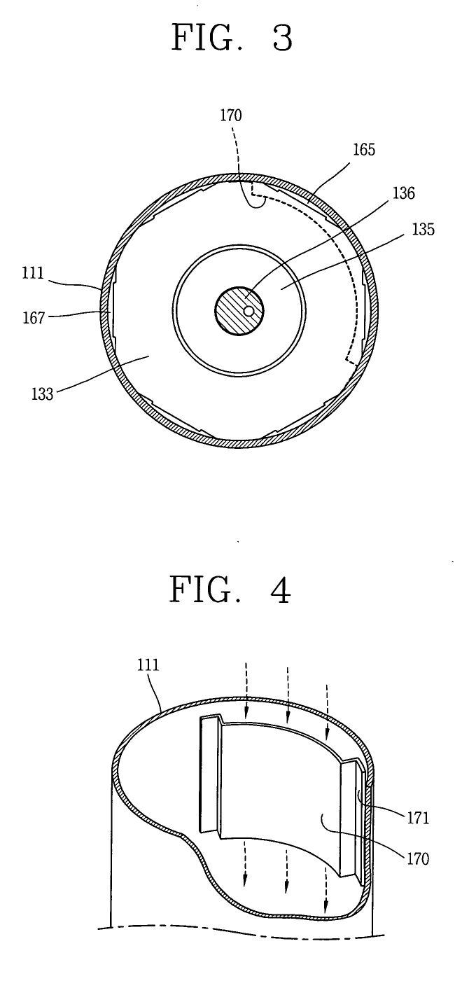

FIG. 2 is a longitudinal section view showing a scroll compressor having a refrigerant gas guide structure in accordance with a first embodiment of the present invention, FIG. 3 is a lateral section view of FIG. 2, and FIG. 4 is an enlarged perspective view showing an important part of the scroll compressor having a refrigerant gas guide structure in accordance with the first embodiment of the present invention.

As shown therein, the scroll compressor having a refrigerant gas guide structure 100 in accordance with the first embodiment of the present invention includes: a casing 111 forming a hermetic receiving space therein; a compression part 141 received in the casing 111 and compressing a refrigerant gas; a motor part 131 installed in the casing 111 and supplying a driving force to the compression part 141; and a gas guide member 170 installed in the casing 111, for guiding a refrigerant gas to be discharged through a discharge hole 145.

A suction pipe 113 for sucking a refrigerant gas is formed at one side of the casing 111, and a discharge pipe 115 for discharging a refrigerant gas is formed at the other side of the casing 111.

Inside the casing 111, an upper frame 121 and a lower frame 130 are separately installed at upper and lower parts of the casing 111 in order to support the compression part 141 and the motor part 131.

The compression part 131 includes a stator 133 installed in the casing 111 and a rotor 135 rotatably received/installed, centering around a rotary shaft 136 vertically disposed in the stator 133.

An eccentric portion 137 is formed at an upper portion of the rotary shaft 136, and a lubrication oil supply path 138 for supplying lubrication oil 118 contained in a lubrication oil storing part 117 of a lower portion of the casing 111 to the compression part 141 is formed inside the rotary shaft 136.

A lubrication oil supply part 139 is formed at a lower portion of the rotary shaft 136 such that the lubrication oil 118 stored in the lubrication storing part 117 can be supplied to the compression part 141 along the lubrication oil supply path 138 during the rotation of the rotary shaft.

The compression part 141 includes a fixed scroll 143 having a wrap 144 of an involute shape and coupled to an upper side of the upper frame 121, and an orbiting scroll 153 having a wrap 154 of an involute shape, forming a compression space of a refrigerant gas by being interlocked with the fixed scroll 143, coupled with the eccentric part 137 and orbiting relative to the eccentric part 137. A discharge hole 145 for discharging the compressed refrigerant gas is formed at the center portion of an upper surface of the fixed scroll 143.

A first gas passage hole 161 is formed between the casing 111 and the upper frame 121 and between the casing 111 and the fixed scroll 143, a second gas passage hole 163 is formed between the casing 111 and one part of the stator 133, and a third gas passage hole 165 is formed between the gas guide member 170 and the casing 111, and a fourth gas passage hole is formed between the casing 111 and the counter part of the stator 133.

An upper and lower part of the gas guide member 170 is opened, and flange parts 171 coupled with the inside of the casing 111 are curvedly formed at both sides of the gas guide member 170, respectively.

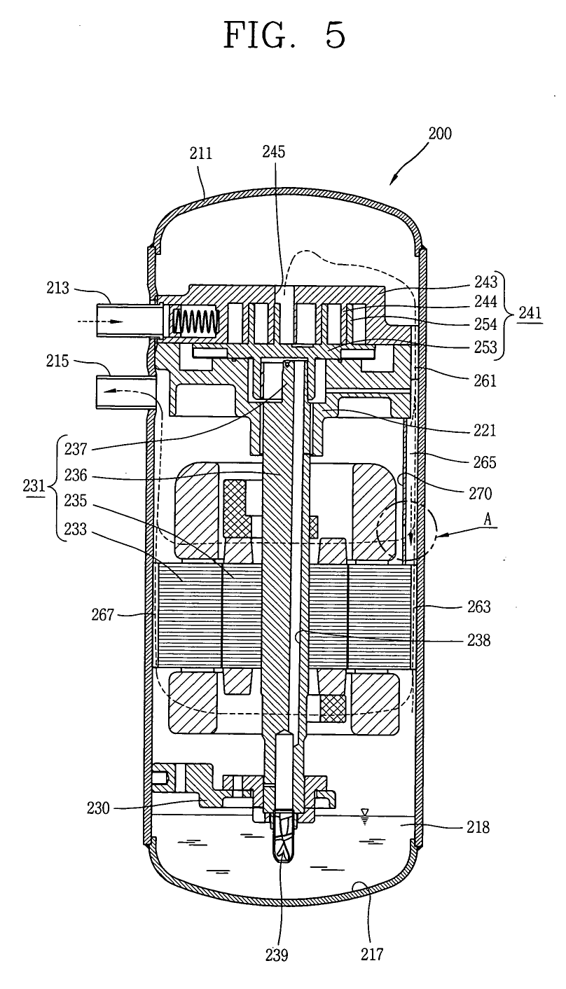

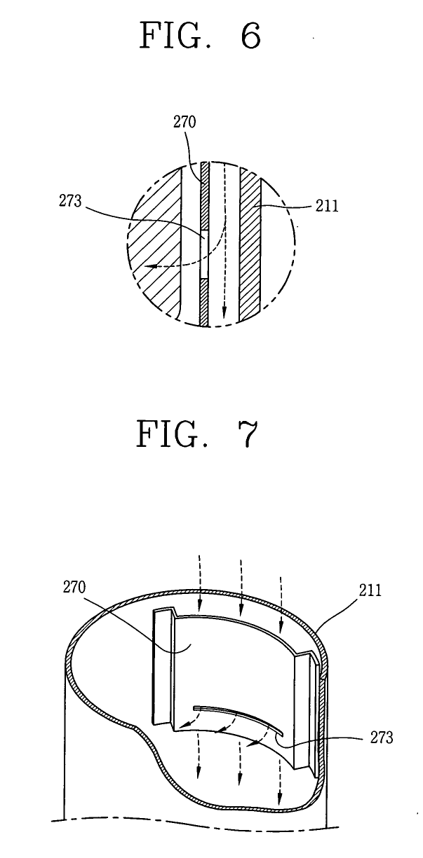

Meanwhile, FIG. 5 is a longitudinal section view of a scroll compressor having a refrigerant gas guide structure in accordance with a second embodiment of the present invention, FIG. 6 is an enlarged view of “A” of FIG. 5, and FIG. 7 is a enlarged perspective view showing an important part of the scroll compressor having a refrigerant gas guide structure in accordance with the second embodiment of the present invention.

As shown therein, the conventional scroll compressor having a refrigerant gas guide structure 200 in accordance with the second embodiment of the present invention includes: a casing 211 forming a hermetic receiving space therein; a compression part 241 received in the casing 211 and compressing a refrigerant gas; a motor part 231 installed in the casing 211 and supplying a driving force to the compression part 241; and a gas guide member 270 installed in the casing 211, for guiding a refrigerant gas to be discharged through a discharge hole 245.

A suction pipe 213 for sucking a refrigerant gas is formed at one side of the casing 211, and a discharge pipe 215 for discharging a refrigerant gas is formed at the other side of the casing 211.

Inside the casing 211, an upper frame 221 and a lower frame 230 are separately installed at upper and lower parts of the casing 211 in order to support the compression part 241 and the motor part 231.

The compression part 231 includes a stator 233 installed in the casing 211 and a rotor 235 rotatably received/installed, centering around a rotary shaft 236 vertically disposed in the stator 233.

An eccentric portion 237 is formed at an upper portion of the rotary shaft 236, and a lubrication oil supply path 238 for supplying lubrication oil 218 contained in a lubrication oil storing part 217 inside the casing 211 to the compression part 241 is formed inside the rotary shaft 236.

A lubrication oil supply part 239 is formed at a lower portion of the rotary shaft 236 such that the lubrication oil 218 stored in the lubrication storing part 217 can be supplied to the compression part 241 along the lubrication oil supply path 238 during the rotation of the rotary shaft.

The compression part 241 includes a fixed scroll 243 having a wrap 244 of an involute shape and coupled to an upper side of the upper frame 221, and an orbiting scroll 253 having a wrap 254 of an involute shape, forming a compression space of a refrigerant gas by being interlocked with the fixed scroll 243, coupled with the eccentric part 237 and orbiting relative to the eccentric part 237. A discharge hole 245 for discharging the compressed refrigerant gas is formed at the center portion of an upper surface of the fixed scroll 243.

A first gas passage hole 261 is formed between the casing 211 and the upper frame 221 and between the casing 211 and the fixed scroll 243, a second gas passage hole 263 is formed between the casing 211 and one part of the stator 233, a third gas passage hole 265 is formed between the gas guide member 270 and the casing 211, and a fourth gas passage hole 267 is formed between the casing 211 and the counter part of the stator 233.

An upper and lower part of the gas guide member 270 is opened, and flange parts 271 coupled with the inside of the casing 211 are curvedly formed at both sides of the gas guide member 270, respectively.

A gas exhaust hole 273 is horizontally cut at the center of the gas guide member 270 such that a part of a refrigerant gas passing the third gas passage hole 265 can be introduced into the discharge pipe 215.

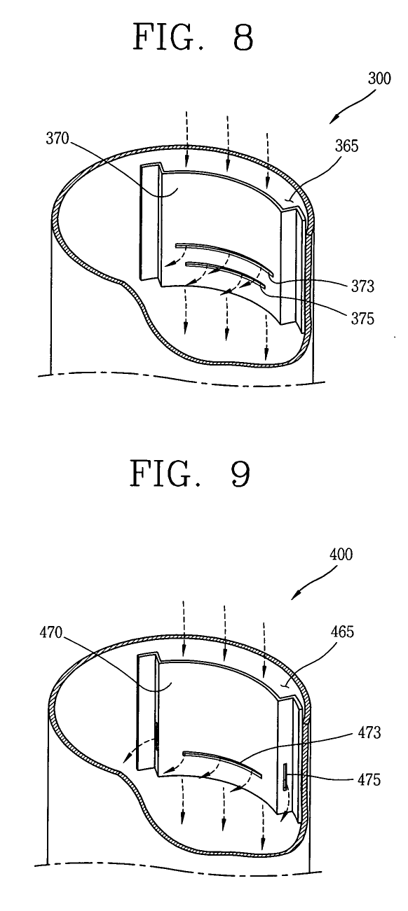

Meanwhile, FIG. 8 is an enlarged perspective view showing an important part of the scroll compressor having a refrigerant gas guide structure in accordance with a third embodiment of the present invention.

As shown therein, in a scroll compressor having a refrigerant gas guide structure 300 in accordance with the third embodiment of the present invention, one gas exhaust hole 373 is horizontally cut at the center of the gas guide member 370 such that a part of a refrigerant gas passing the third gas passage hole 365 can be introduced into the discharge pipe (not shown), and another gas exhaust hole 375 is horizontally cut under the gas exhaust hole 373.

Meanwhile, FIG. 9 is an enlarged perspective view showing an important part of a scroll compressor having a refrigerant gas guide member in accordance with a fourth embodiment of the present invention.

As shown therein, in a scroll compressor having a refrigerant gas guide structure 400 in accordance with the fourth embodiment of the present invention, one gas exhaust hole 473 is horizontally cut at the center of the gas guide member 470 such that a part of a refrigerant gas passing the third gas passage hole 465 can be introduced into the discharge pipe (not shown), and another gas exhaust hole 475 is horizontally cut at a side surface of the gas guide member 470.

With reference to FIGS. 2 to 4, the operation of the scroll compressor having a refrigerant gas guide structure 100 in accordance with the first embodiment of the present invention will be described.

As shown in FIGS. 2 and 4, when the power is applied to the motor part 131 and thus the rotor 135 is rotated, the orbiting scroll 153 eccentrically moves with respect to the fixed scroll 143. At this time, the refrigerant gas sucked through the suction pipe 113 moves toward the center portion of the fixed scroll 153, is compressed and then is discharged to the discharge hole 145.

The refrigerant gas having been discharged through the discharge hole 145 passes the first gas passage hole 161, is introduced into the third gas passage hole 165, the second gas passage hole 163 and the fourth gas passage hole 167 by the guide of the gas guide member 170, and then is discharged to the outside of the casing 111 through the discharge pipe 115. After circulating according to a freezing cycle, the refrigerant gas having been discharged outside of the casing 111 flows into the inside of the casing 111 again through the suction pipe 113. Such processes are repeated.

Simultaneously, the lubrication oil supply part 139 supplies the lubrication oil 118 stored in the lubrication storing part 117 to each constituting part such as the compression part 141 along the lubrication oil supply path 138. The lubrication oil having been supplied to each constituting part is returned to the lubrication oil storing part 117.

As described, since the refrigerant gas discharged through the discharge hole 145 is introduced into the third gas passage hole 165, the second gas passage hole 163 and the fourth gas passage hole 167 by the gas guide member 170 and then is discharged outside the casing 111 through the discharge pipe 115, the lubrication oil to be returned to the lubrication oil storing part 117 can be prevented from being discharged outside the casing 111 together with the refrigerant gas.

As described so far, the present invention efficiently prevents the lubrication oil from being spilt into the outside of the casing together with a refrigerant gas through the discharge pipe during the suction, compression and discharge of the refrigerant gas, so that the lubrication oil can remain inside the casing all the time. Therefore, abrasion of each part can be reduced to thereby enhance the performance of each part and the compression performance of the compressor.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A scroll compressor having a refrigerant gas guide structure, comprising:
a casing forming a hermetic receiving space therein, and having a suction pipe for sucking a refrigerant gas and a discharge pipe for discharging a refrigerant gas;
a fixed scroll having a wrap of an involute shape and a discharge hole for discharging a compressed refrigerant gas, and disposed in the casing;
an orbiting scroll having a wrap of an involute shape, coupled with the fixed scroll and orbiting relative to the fixed scroll; and
a gas guide member installed in the casing, for guiding the refrigerant gas discharged through the discharge hole.

2. The scroll compressor of claim 1, wherein a first gas passage hole is formed between the casing and an upper frame and between the casing and the fixed scroll, a second gas passage hole is formed between the casing and one part of a stator, and a third gas passage hole is formed between the gas guide member and the casing, and a fourth gas passage hole is formed between the casing and the counter part of the stator.

3. The scroll compressor of claim 2, wherein the refrigerant gas having been discharged through the discharge hole passes the first gas passage hole, the third gas passage hole, the second passage hole and the fourth passage hole and then is discharged outside the discharge pipe.

4. The scroll compressor of claim 2, wherein flange parts coupled with the inside of the casing are curvedly formed at both sides of the gas guide member, respectively.

5. The scroll compressor of claim 4, wherein a gas exhaust hole is formed at the center of the gas guide member such that a part of a refrigerant gas passing the third gas passage hole can be introduced outside the discharge pipe.

6. The scroll compressor of claim 5, wherein the gas exhaust hole is horizontally cut.

7. The scroll compressor of claim 6, wherein another gas exhaust hole is further formed at a position adjacent to the gas exhaust hole.

8. The scroll compressor of claim 7, wherein a gas exhaust hole is formed at a side surface of the gas guide member.

9. A scroll compressor having a refrigerant gas guide structure, comprising:
a fixed scroll having a wrap of an involute shape and a discharge hole for discharging a compressed refrigerant gas, and disposed in the casing;
an orbiting scroll having a wrap of an involute shape, coupled with the fixed scroll, and orbiting relative to the fixed scroll; and
a gas guide member installed in the casing, for guiding a refrigerant gas inside the casing.

10. The scroll compressor of claim 9, wherein an upper and lower part of the gas guide member is opened, and flange parts coupled with the inside of the casing are curvedly formed at both sides of the gas guide member, respectively.

11. The scroll compressor of claim 9, wherein a plurality of gas exhaust holes are formed at the center portion and both side surfaces of the gas guide member.
